(19) United States
(12) Patent Application Publication
(10) Pub. No.: US 2017/0289571 A1
(43) Pub. Date: Oct. 5, 2017

(54) TEMPORAL CONTROL FOR SPATIALLY ADAPTIVE TONE MAPPING OF HIGH DYNAMIC RANGE VIDEO

(71) Applicant: INTEL CORPORATION, Santa Clara, CA (US)

(72) Inventors: Dragomir El Mezeni, Belgrade (RS); Nemanja Tonic, Belgrade (RS); Stojan Rakic, Belgrade (RS)

(73) Assignee: INTEL CORPORATION, Santa Clara, CA (US)

(21) Appl. No.: 15/088,870

(22) Filed: Apr. 1, 2016

(51) Int. Cl. H04N 19/593; H04N 19/117; H04N 19/186; H04N 19/182; H04N 19/503

(52) U.S. Cl. CPC H04N 19/593; H04N 19/182; H04N 19/503; H04N 19/186; H04N 19/117

(57) ABSTRACT

Techniques are provided for temporal control of a spatially adaptive tone mapping (SATM). The techniques can be applied to a sequence of video images (e.g., high dynamic range (HDR) video). The temporal control may reduce flickering and other undesirable artifacts that can be introduced by SATM processing. An example system includes an SATM circuit configured to perform SATM on sequential image frames of an input video, to reduce the dynamic range of the video to a level suitable for display on a conventional (lower dynamic range) device. The SATM operation is based on frame parameters. The system also includes a parameter smoothing circuit configured to apply a smoothing filter to the parameters used on the current frame to generate a new set of parameters for use by the SATM circuit on the next frame. The system also includes an adaptation circuit to compress variation of SATM exposure correction over time.

### BACKGROUND

Cameras and other imaging devices, with the capability to provide increasingly high dynamic range (HDR) images, are becoming more widely available. Such HDR images are able to capture a wider range of luminosity or brightness than is possible with more traditional imaging devices and techniques. This can be useful when the subject matter of the photograph contains both extremely bright and extremely dark regions, such as, for example, a mixture of sunlit areas and shadowed areas. HDR images may be obtained with sensors that have greater dynamic range, and which can generate pixel values with an increased number of bits to represent that entire range, without losing detail through truncation. HDR video cameras, which can generate a sequence of such HDR image frames, are also becoming increasingly available.

Currently, however, most conventional display devices have much more limited dynamic range (e.g., low dynamic range or LDR), and are unable to reproduce such HDR images in a visually acceptable format. Attempts to display an HDR image on a standard or conventional LDR display typically result in regions of the image that are either washed out or blacked out, or both, with a resulting loss of image detail. Existing solutions to this problem attempt to reduce image contrast through either global or local tone (e.g., luminosity and/or color) mapping operations. Global operators apply the same mapping function to each image pixel and provide global contrast reduction, but typically suffer from loss of detail in the dark and bright areas of the image. Local operators, on the other hand, are better at preserving local image features such as details in bright and dark areas, but generally suffer from low global contrast and may introduce image artifacts such as halo effects.

Additionally, due to the fact that tone mapping operations attempt to maximize the utilization of all of the available dynamic range, relatively small changes in the image scene (for example the introduction or removal of a light source) can lead to dramatic changes in the tone mapped output. This behavior is especially problematic when tone mapping operations are applied to sequences of HDR images, as in the case of HDR video, because it can introduce annoying flickering (and other temporal artifacts) in the output LDR sequence.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features and advantages of embodiments of the claimed subject matter will become apparent as the following Detailed Description proceeds, and upon reference to the Drawings, wherein like numerals depict like parts, and in which:

FIG. 1 is a top level diagram of a spatially adaptive tone mapping system with temporal control, configured in accordance with certain of the embodiments disclosed herein.

FIG. 2 is a more detailed system diagram of a spatially adaptive tone mapping circuit, configured in accordance with certain of the embodiments disclosed herein

FIG. 3 illustrates image frames associated with processing by the spatially adaptive tone mapping circuit, configured in accordance with certain of the embodiments disclosed herein.

FIG. 4 is a more detailed block diagram of the log domain pre-processing circuit of the spatially adaptive tone mapping circuit, configured in accordance with certain of the embodiments disclosed herein.

FIG. 5 is a more detailed block diagram of the linear domain processing circuit of the spatially adaptive tone mapping circuit, configured in accordance with certain of the embodiments disclosed herein.

FIG. 6 illustrates a plot of one example tone compression function associated with processing by the spatially adaptive tone mapping circuit, configured in accordance with certain of the embodiments disclosed herein.

FIG. 7 illustrates a plot of another example tone compression function associated with processing by the spatially adaptive tone mapping circuit, configured in accordance with certain of the embodiments disclosed herein.

FIG. 8 is a more detailed block diagram of the temporal control circuit and the spatially adaptive tone mapping system, configured in accordance with certain of the embodiments disclosed herein.

FIG. 9 is a plot illustrating results of temporal control processing over a range of video image frames, in accordance with certain of the embodiments disclosed herein.

FIG. 10 is a plot illustrating the effect of temporal control processing on the base offset parameter over a range of video image frames, in accordance with certain of the embodiments disclosed herein.

FIG. 11 is a plot illustrating the effect of temporal control processing on the base ratio parameter over a range of video image frames, in accordance with certain of the embodiments disclosed herein.

FIG. 12 is a plot illustrating the effect of temporal control processing on the base min parameter over a range of video image frames, in accordance with certain of the embodiments disclosed herein.

FIG. 13 is a plot illustrating the effect of temporal control processing on the base max parameter over a range of video image frames, in accordance with certain of the embodiments disclosed herein.

FIG. 14 is a plot illustrating results of temporal control processing with varying adaptation parameters over a range of video image frames, in accordance with certain of the embodiments disclosed herein.

FIG. 15 is a flowchart illustrating a methodology for spatially adaptive tone mapping with temporal control, in accordance with certain of the embodiments disclosed herein.

FIG. 16 is a block diagram schematically illustrating a system platform configured to carry out spatially adaptive tone mapping with temporal control, configured in accordance with certain of the embodiments disclosed herein.

Although the following Detailed Description will proceed with reference being made to illustrative embodiments, many alternatives, modifications, and variations thereof will be apparent to those skilled in the art.

### DETAILED DESCRIPTION

Generally, this disclosure provides techniques for temporal control of spatially adaptive tone mapping (SATM). The techniques can be used, for example, for the display or reproduction of high dynamic range (HDR) video on devices with lower dynamic range (LDR) capability. The techniques for SATM processing of an input HDR image may be used, for example, to enable the preservation of details, particularly in bright and dark regions of the image. Additionally, the techniques for temporal control may reduce flickering and other undesirable artifacts that can be introduced by the SATM operation.

In accordance with an embodiment, the SATM includes a pre-processing operation that is performed in the logarithmic domain and a subsequent dynamic range compression operation that is performed in the linear domain. In the pre-processing operation, luminance data from the input HDR image is decomposed into a number of layers or planes of varying detail using a guided edge-aware filter that provides for relatively more efficient execution. For instance, the input HDR image can be decomposed into a base layer, a small scale detail layer, and a large scale detail layer, in one example case. The small scale detail layer and the large scale detail layer allow for improved control over image sharpness and local contrast of the output image. The base layer is partially compressed, and the details layers are enhanced using a spatially varying gain map configured to provide contrast boost in dark image areas. After conversion back to the linear domain, the base layer is further compressed using a log based tone compression function configured to dynamically adapt to statistics of the base layer to achieve improved contrast enhancement, and to preserve the details in both highlights and shadows by limiting the range of the compressed base layer. The compressed layers can then be recombined to generate compressed luminance data for an output image with enhanced details suitable for display on an LDR device.

As will be further appreciated in light of this disclosure, the techniques provided herein can be applied for temporal control of the SATM operations, over a sequence of image frames of an HDR video, so as to provide for smoothing of the operational parameters used by the SATM process, which can vary widely from frame to frame and lead to flickering and other undesirable effects. The temporal control techniques may also provide for an adaptation operation to compress the variation of SATM exposure correction over time, according to still further example embodiments.

The techniques described herein provide for generally increased computational efficiency compared to existing local tone mapping methods, according to some embodiments, and as will be appreciated in light of this disclosure. Additionally, these techniques do not require storage of previous frames for processing of the current frame and may therefore be suitable for use in real-time image processing implementations including video applications. Note, however, that such frame storage can be used if so desired for whatever reason, in some embodiments. The techniques can be implemented in hardware or software or a combination thereof.

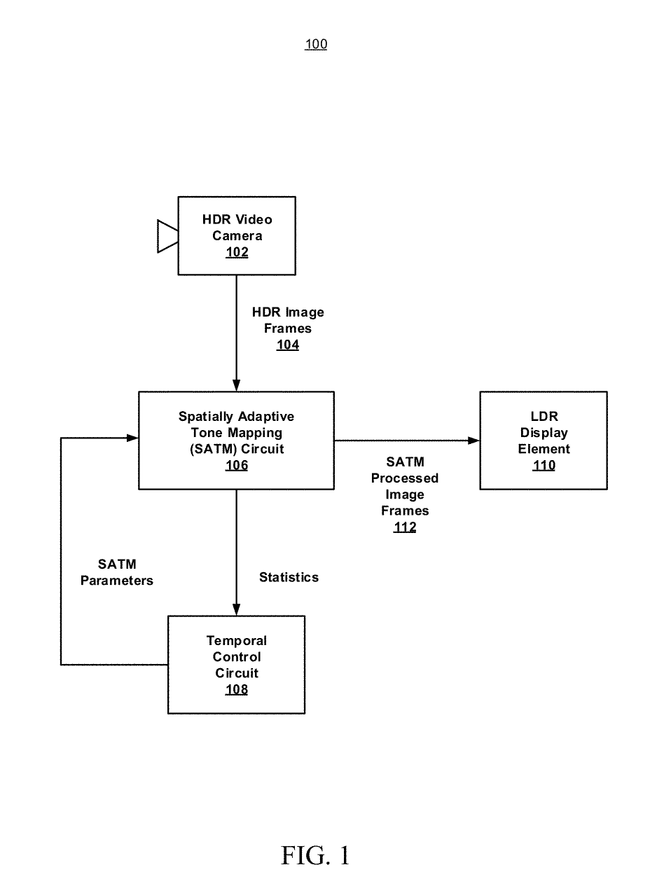

FIG. 1 is a top level diagram 100 of a spatially adaptive tone mapping system with temporal control, configured in accordance with certain of the embodiments disclosed herein. An HDR video camera 102, or other source, is shown to provide a sequence of HDR image frames 104 to an SATM circuit 106. The SATM circuit is configured to reduce the dynamic range of the HDR image frames so that the processed frames 112 may be displayed on a conventional LDR display element 110. In some embodiments, the SATM processed image frames 112 may be stored for subsequent display, further processing or any other desired purpose. Temporal control circuit 108 is also shown and may be configured to filter and process the operational SATM parameters that were used on a previous image frame for use on the current frame, based on statistics of the current frame, as will be described in greater detail below.

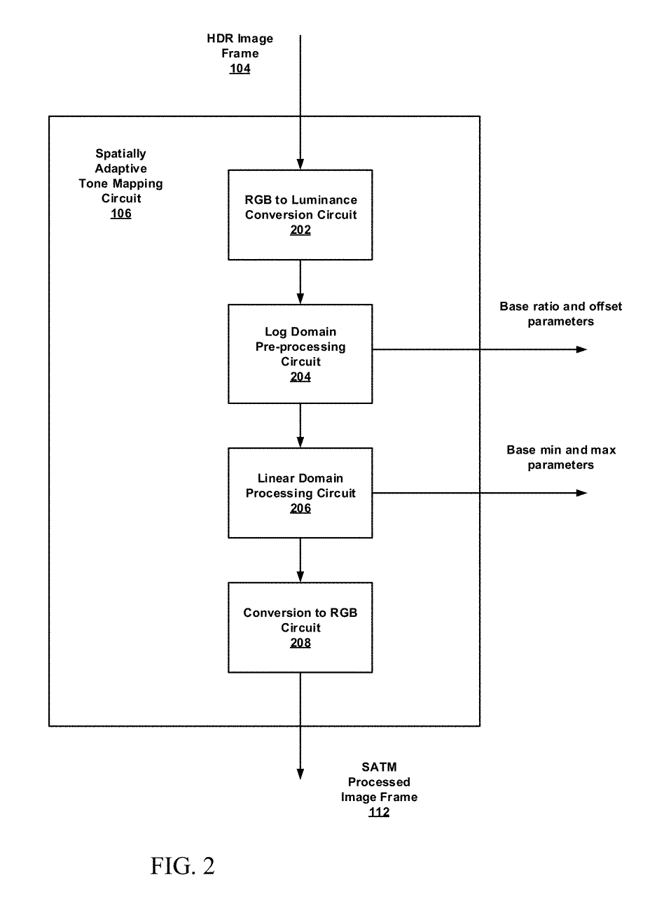

FIG. 2 is a more detailed system diagram of the spatially adaptive tone mapping circuit 106, configured in accordance with certain of the embodiments disclosed herein. The SATM circuit 106 is shown to include an RGB to luminance conversion circuit 202, a log domain pre-processing circuit 204, a linear domain processing circuit 206 and a conversion to RGB circuit 208. SATM circuit 106 may be configured to perform spatially adaptive tone mapping on a received HDR image frame 104 and generate a processed image frame 112 suitable for display on a lower dynamic range display element 110 or other type of image reproduction device.

The RGB to luminance conversion circuit 202 may be configured to process the input or received HDR image 104, presented in a typical RGB format, to extract input luminance data Y_{IN} for compression. Typically only the luminance data is compressed since it provides achromatic information that describes or represents the lighting levels of the image. The input RGB values for each image pixel are represented by a given number of bits for each color channel (RGB). HDR image RGB values generally comprise a greater numbers of bits than LDR images. The RGB channels may be normalized to a range of 0 to 1, where 1 represents a maximum pixel value associated with associated with a maximum allowable absolute light level. Luminance may then be calculated, for example, using an ITU-R BT.709 standard transform (or other suitable method):

Y_{IN}=0.2126·R+0.7152·G+0.0722·B

In some embodiments, the HDR image 104 may be provided in a luminance/chrominance format, in which case the luminance channel will be readily available. Of course, image data may also be provided in other formats and other appropriate conversion techniques may be used in those cases.

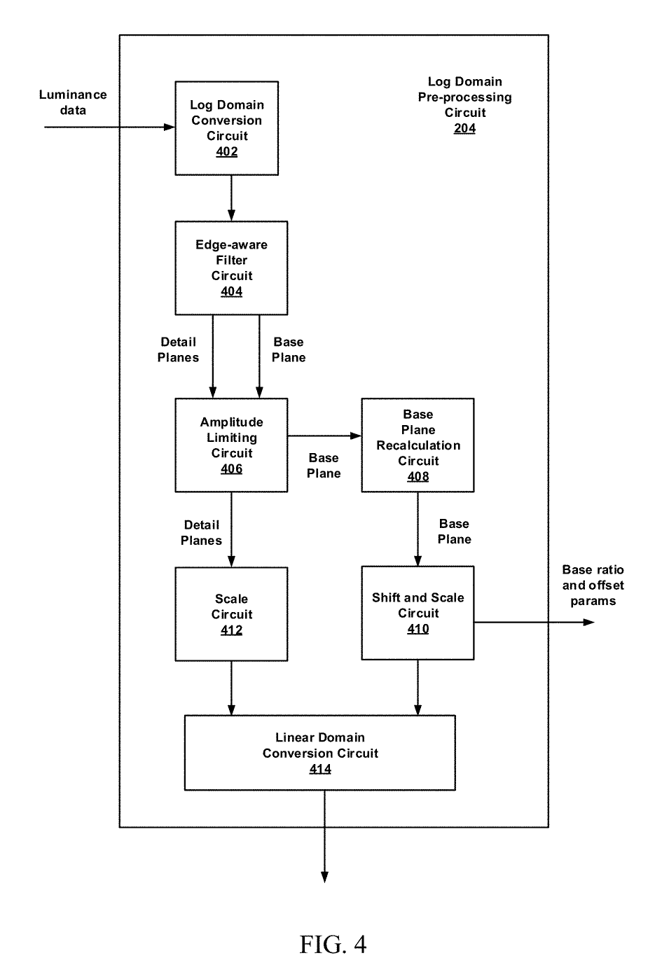

The log domain pre-processing circuit 204 may be configured to perform a pre-processing operation in the logarithm domain where the luminance data is decomposed into a number of layers or planes of varying detail (e.g., base layers, small scale detail layer and large scale detail layer) using a guided edge-aware filter. The base layer is partially compressed, and the details layers are enhanced using a spatially varying gain map configured to provide contrast boost in dark image areas. The log domain pre-processing circuit 204 will be described in greater detail in connection with FIG. 4.

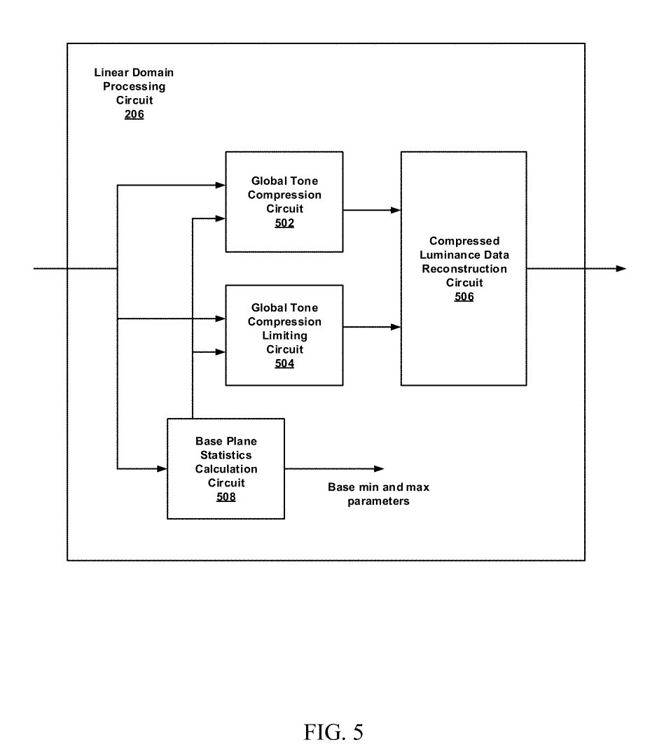

The linear domain processing circuit 206 may be configured to provide further compression, after conversion back to the linear domain, using a log based tone compression function configured to dynamically adapt to statistics of the base layer. The linear domain processing circuit 206 may then reconstruct compressed luminance data from the base and detail layers. The linear domain processing circuit 206 will be described in greater detail in connection with FIG. 5. The conversion to RGB circuit 208 may be configured to convert the compressed luminance data back to an RGB image, as will also be described below. The converted RGB image will be suitable for display on a conventional or LDR type display element 110.

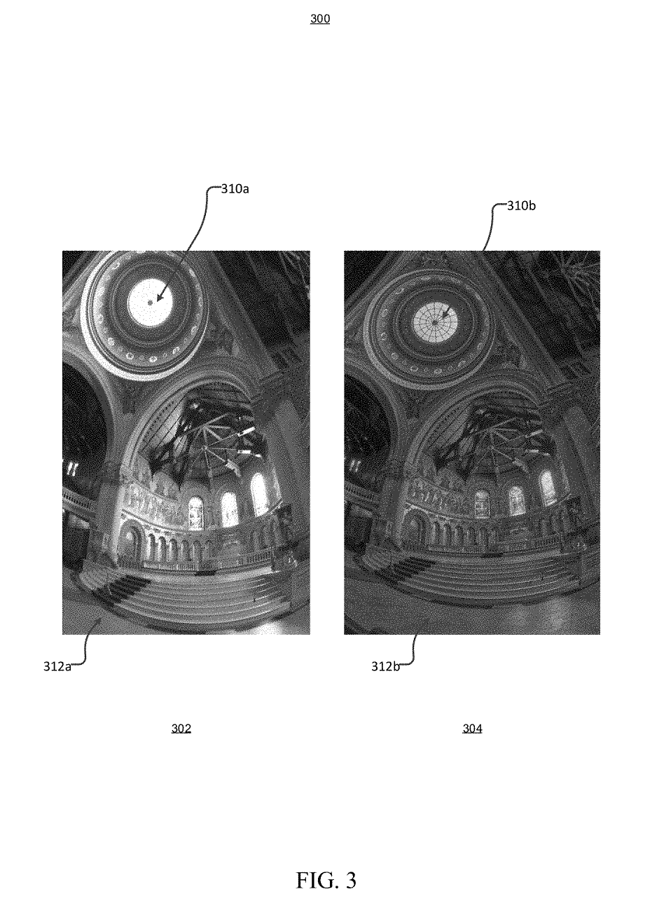

FIG. 3 illustrates image frames associated with processing by the spatially adaptive tone mapping circuit, configured in accordance with certain of the embodiments disclosed herein. Image 302 illustrates an attempt to display an HDR image on a standard display or reproduction device without the benefit of tone mapping. As can be seen, image details are lost in areas of relatively extreme brightness, such as the windows 310a. Indeed, areas of only moderate brightness, such as the floor 312a suppress much of the detail in the tile flooring. In contrast, image 304 illustrates the results of processing based on the spatially adaptive tone mapping techniques described herein, according to one example embodiment. An improvement can be seen in the detail visible in the window areas 310b and flooring 312b as well as in other areas.

FIG. 4 is a more detailed block diagram of the log domain pre-processing circuit 204 of the spatially adaptive tone mapping circuit 106, configured in accordance with certain of the embodiments disclosed herein. The log domain pre-processing circuit 204 is shown to include a log domain conversion circuit 402, an edge-aware filter circuit 404, an amplitude limiting circuit 406, a base plane recalculation circuit 408, a scaling circuit 412, a shifting and scaling circuit 410 and a linear domain conversion circuit 414.

Log domain conversion circuit 402 may be configured to convert the input luminance data Y_{IN}, from a linear domain to a logarithm domain, for example according to the equation:

Y_{LOG}=log₂(Y_{IN}+ε)

In a preferred embodiment, the logarithm operation is a base 2 log, although other log base values are possible. A small value, epsilon, may be added to the luminance data prior to performing the log operation to ensure that the argument to the logarithm is not equal to zero which is a mathematically undefined operation. The value of epsilon may be chosen to be small enough to have a negligible (e.g., visually imperceptible) effect on the results of the processing, according to some embodiments.

Edge-aware filter circuit 404 may be configured to decompose the logarithm domain luminance data (Y_{LOG}) into a base layer (B_{LOG}), a small scale detail layer (Ds_{LOG}) and a large scale detail layer (Dl_{LOG}). In some embodiments, the edge-aware filter circuit is implemented as an edge-aware guided filter using known techniques in light of the present disclosure. The edge-aware guided filter may accept filter radius parameters, R, each of which is uniquely selected to generate the base layer, the small scale detail layer and the large scale detail layer. The length of the filter, L, is generally related to the selected radius R, for example L=2R+1. In some embodiments, small scale details may be associated with an image radius R in the range of 4 to 5 pixels; and large scale details associated with an image radius R in the range of 30 to 35, although other values are possible. In some embodiments, the filter length L for the large scale detail image region is typically selected to be approximately 6% of the smaller dimension of the input image (either width or height). It will be appreciated that the base layer is essentially a low-pass filtered (or blurred) version of the luminance data while the detailed layers are relatively more high-pass filtered versions.

The use of an edge-aware guided filter in the decomposition process may provide the best tradeoff between image quality and processing complexity. It generally provides better detail decomposition and is less prone to gradient reversals artifacts than bilateral filters and it is typically faster than other edge-aware approaches. It can be calculated relatively efficiently since it employs only 4 mean filtering (smoothing) functions which can be implemented in a processing time proportional to the image size (total number of pixels) and is independent of the filter size.

The small scale detail layer or plane (Ds_{LOG}) is obtained using the filter with a relatively small radius parameter, for example on the order of 4 to 5 pixels. Small details are associated with smaller scale or “micro” contrast and provide the sensation of image sharpness. The large scale detail layer or plane (Dl_{LOG}) is obtained using the filter with a relatively large radius parameter, for example on the order of 30 to 35 pixels. Large details provide information about larger features and illumination changes and they are generally responsible for local contrast. This separation into multiple layers provides additional control over detail enhancement. For example, local contrast can be increased by amplification of large details while avoiding over-sharpening by applying smaller gain to small details.

Amplitude limiting circuit 406 may be configured to limit the amplitudes of the detail layers (Ds_{LOG}, Dl_{LOG}) to predefined values, dsLimit for small details and dlLimit for large details. The value of this limit restricts the level of detail which is allowed to be passed from input to the detail layers. The motivation for detail limitations is to enable control over sudden transitions which can be caused by impulse noise, dead pixels, specular areas or gradient reversals. Amplitude limiting may be bypassed during implementation by setting the detail limit values to zero.

Base plane recalculation circuit 408 may be configured to recalculate the base layer after the detail limitations are imposed by amplitude limiting circuit 406 to avoid any loss of information. The operations of the edge-aware filter circuit 404, amplitude limiting circuit 406 and base plane recalculation circuit 408, as described above, may be summarized by the following equations:

Bs_{LOG}=guidedFilter(Y_{LOG},radiusₛₘₐₗₗ,epsₛₘₐₗₗ)

Ds_{LOG}=Y_{LOG}−Bs_{LOG}

Ds_{LOG}=clip(Ds_{LOG},dsLimit)

Bs_{LOG}=Y_{LOG}−Ds_{LOG}

B_{LOG}=guidedFilter(Bs_{LOG},radius_{large},eps_{large})

Dl_{LOG}=B_{LOG}−Bs_{LOG}

Dl_{LOG}=clip(Dl_{LOG},dlLimit)

B_{LOG}=Bs_{LOG}−Dl_{LOG}

In the above equations, “guided filter” refers to the edge-aware filter circuit 404, “clip” refers to the amplitude limiting circuit 406 and the eps parameter is used to select a desired level of filter blurring (e.g., the filter cutoff frequency).

Scaling circuit 412 may be configured to adjust the amplitudes of the data in the detail layers, and shifting and scaling circuit 410 may be configured to adjust the amplitudes of the data in the base layers, such that they are mapped into a selected range of values, to achieve an initial log domain tone compression or contrast reduction. Contrast reduction performed in the logarithm domain is used to limit widely varying dynamic ranges of input images into a predefined range, as opposed to tone compression performed in the linear domain which may be used to adjust final appearance of the tone mapped image.

In some images, poor exposure settings and/or problematic transitions from absolute to relative luminance may result in a maximum relative luminance value that is less than unity in the linear domain (or equivalently, smaller than zero in the logarithm domain). This can result in inefficient usage of output pixel values, that is to say, not taking advantage of the entire range of available values. Shifting and scaling circuit 410 may be configured to remap the base layer values to compensate for exposure errors and to place the largest log luminance value at zero. Scaling may thus ensure that a histogram of the log luminance data fits into a predefined contrast ratio. The following equation illustrates the calculation of the remapped log domain base layer, \hat{B}_{LOG}, where offset is the shift value and ratio is the scale factor.

$$offset = - max ( {B}_{LOG} )$$

$$ratio = \frac{targetRange}{max ( {B}_{LOG} ) - min ( {B}_{LOG} )}$$

$${\hat{B}}_{LOG} = ratio \cdot ( {B}_{LOG} + offset )$$

In some embodiments, targetRange, may be set to a value of approximately 5, generally corresponding to an exposure value (e.g., a photographic stop) of 5.

Linear domain conversion circuit 414 may be configured to convert the modified base and detail layers back to the linear domain by applying a base 2 exponentiation function, for example:

B=2^{\hat{B}}^{_{LOG}}

D=2^{\hat{D}l}^{_{LOG}}^{+\hat{D}s}^{_{LOG}}⁾

FIG. 5 is a more detailed block diagram of the linear domain processing circuit 206 of the spatially adaptive tone mapping circuit 106, configured in accordance with certain of the embodiments disclosed herein. The linear domain processing circuit 206 is shown to include a global tone compression circuit 502, a global tone compression limiting circuit 504, base plane statistics calculation circuit 508, and a compressed luminance data reconstruction circuit 506.

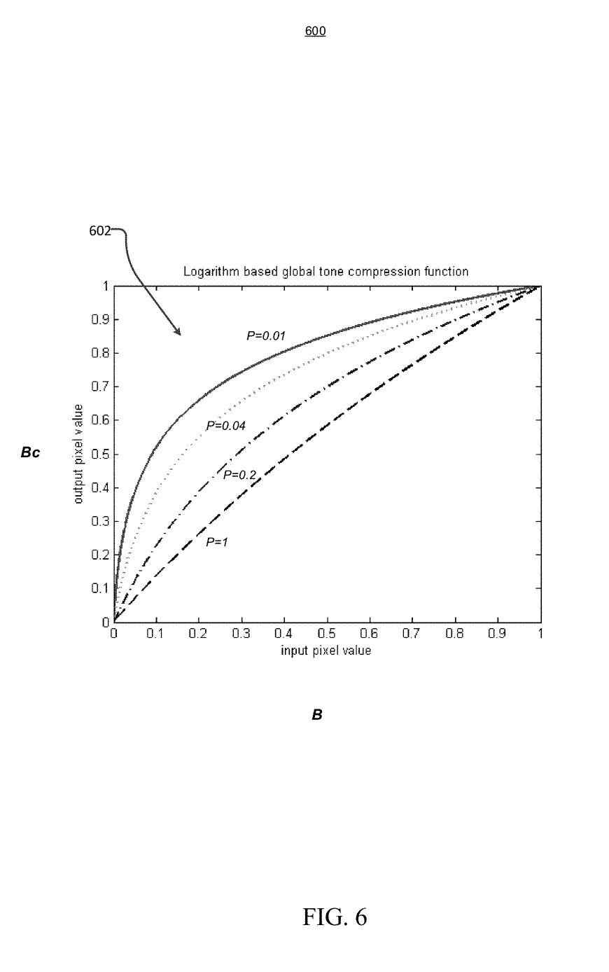

Global tone compression circuit 502 may be configured to apply further tone compression in the linear domain. After log domain processing, a histogram of the base layer in the linear domain may still have a relatively large peak associated with the lowest pixel values implying low contrast in shadow areas. Processing in the logarithm domain has placed the base layer histogram into a predefined range causing subsequent operations to be less sensitive to the dynamic range of the input image. An improvement in the displayable contrast can be achieved by applying any of the known global tone compression techniques, in light of the present disclosure. Some examples of known global tone compression functions include gamma, logarithmic and rational function tone compression. Since logarithmic tone compression complies with Weber-Fechner's law of just noticeable differences, the compressed base plane B_{c} can be calculated using the following equation for logarithmic compression:

$${B}_{C} = \frac{log ( B + p ) - log ( p )}{log ( 1 + p ) - log ( p )}$$

where p is a parameter that controls the strength of the compression. FIG. 6 illustrates a family of tone compression curves for different values of p={0.01, 0.04, 0.2, 1}. In some embodiments, the parameter p may be adjusted by a user or operator of the system to fine tune the output image.

Straightforward application of tone compression after log domain processing, however, can reduce global contrast and cause a foggy appearance in the output image. Histogram stretching after tone compression can restore global contrast but generally cannot improve local contrast since a large peak will still be present for low pixel values. In order to take full advantage of the tone compression curve for contrast enhancement in dark image areas, the tone compression function may be adjusted to the base plane statistics (e.g., Bₘᵢₙ and Bₘₐₓ), which may be calculated by base plane statistics calculation circuit 508. Additionally, it is not desirable to have the compressed base plane consume the entire output range since clipping of details near each end of the range will occur. This can be avoided by limiting the output range of the tone compression function, leaving enough headroom and footroom for details in dark and bright areas of the image to reduce clipping. Global tone compression limiting circuit 504 may be configured to accomplish this, for example as an alternative to circuit 502, through use of a family of modified tone compression functions as illustrated in FIG. 6. The compressed base plane B_{c} can be calculated using the following equation for logarithmic compression with output limiting:

$${B}_{C} = ( {B}_{Cmax} - {B}_{Cmin} ) \frac{log ( \frac{B - {B}_{min}}{{B}_{max} - {B}_{min}} + p ) - log ( p )}{log ( 1 + p ) - log ( p )} + {B}_{Cmin}$$

where p again is a parameter that controls the strength of the compression. In some embodiments, the parameter p as well as the output range (B_{Cmin} and B_{Cmax}) may be adjusted by a user or operator of the system to fine tune the output image.

Compressed luminance data reconstruction circuit 506 may be configured to combine the compressed base layer and details layer to a compressed luminance layer Y_{C} through multiplication:

Y_{C}=B_{C}·D

The conversion to RGB circuit 208 may be configured to convert the compressed luminance layer Y_{C} back to an RGB image suitable for display on a conventional or LDR type display element 110. The resulting tone mapped output image (R_{OUT}, G_{OUT}, B_{OUT}) may be generated from the input linear RGB values (R_{IN}, G_{IN}, B_{IN}), the input luminance values Y_{IN} and the output compressed luminance, using known techniques in light of the present disclosure. For example a variation of Schlick's method with variable saturation parameter s and gamma correction factor γ may be used as follows:

$${R}_{OUT} = {{Y}_{C} ( \frac{{R}_{IN}}{{Y}_{IN}} )}^{\frac{s}{γ}}$$

$${G}_{OUT} = {{Y}_{C} ( \frac{{G}_{IN}}{{Y}_{IN}} )}^{\frac{s}{γ}}$$

$${B}_{OUT} = {{Y}_{C} ( \frac{{B}_{IN}}{{Y}_{IN}} )}^{\frac{s}{γ}}$$

The parameter γ represents the gamma correction factor needed for correct display of output images. The value of gamma depends on display properties and may be equal to 2.4 for standard RGB color space (sRGB) type devices.

FIG. 6 illustrates a plot 600 of one example tone compression function associated with processing by the spatially adaptive tone mapping circuit, configured in accordance with certain of the embodiments disclosed herein. A family of logarithm based global tone compression curves 602 are shown for converting input pixel values (e.g., from a base plane B) to compressed output pixel values (e.g., for compressed base plane B_{C}). The degree of compression can be varied through selection of values for parameter p, with increasing compression corresponding to smaller values of p.

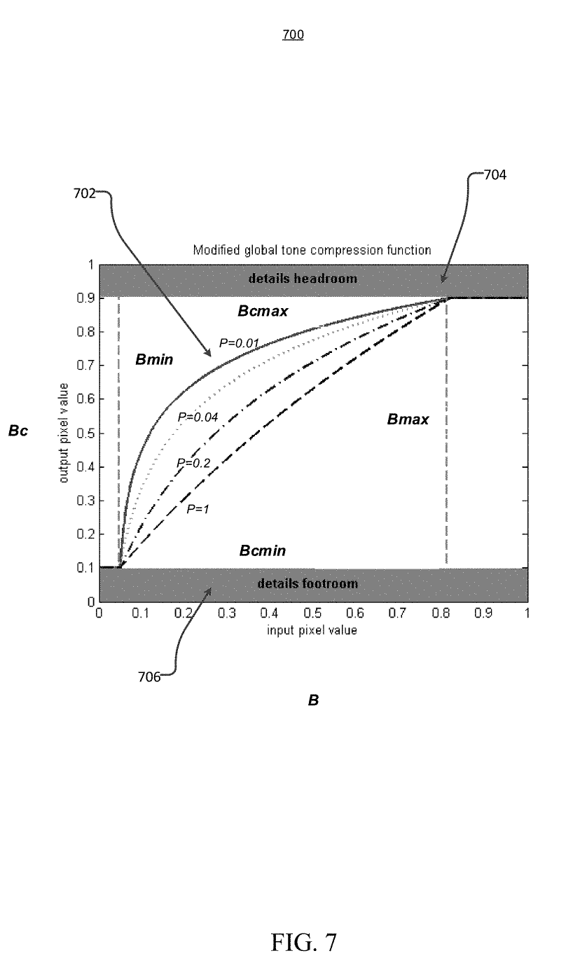

FIG. 7 illustrates a plot 700 of another example tone compression function associated with processing by the spatially adaptive tone mapping circuit, configured in accordance with certain of the embodiments disclosed herein. A family of modified logarithm based global tone compression curves 702 are shown for converting input pixel values (e.g., from a base plane B) to compressed output pixel values (e.g., for compressed base plane B_{C}). The degree of compression can be varied through selection of values for parameter p, with increasing compression corresponding to smaller values of p. These modified compression curves limit the output range of the tone compression function to leave headroom 704 and footroom 706 for details in the dark and bright areas of the image to reduce clipping.

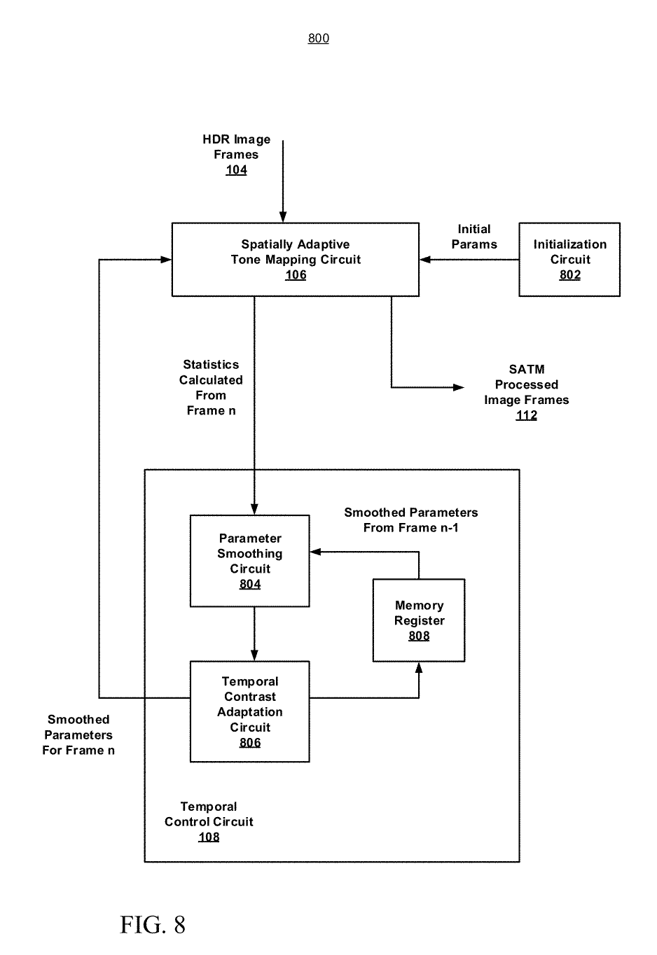

FIG. 8 is a more detailed block diagram of the temporal control circuit 108 and the spatially adaptive tone mapping system, configured in accordance with certain of the embodiments disclosed herein. The temporal control circuit 108 is configured to filter the scene-dependent parameters associated with each image to avoid or reduce relatively rapid changes from frame to frame which may be induced by the SATM processing. The temporal control circuit 108 is shown to include a parameter smoothing circuit 804, a temporal contrast adaptation circuit 806 and a memory register 808.

As described previously, the SATM circuit 106 employs a number of parameters to perform the SATM process on each frame. These parameters include, for example, the shift of the amplitudes of the base layer (base offset), the scale of the amplitudes of the base layer (base ratio), a minimum value of the amplitudes of the base layer (base min), and a maximum value of the amplitudes of the base layer (base max). These parameters are of particular importance in the temporal control process. During the processing of each frame, the SATM circuit 106 is configured to calculate statistics associated with that current frame. Rather than deriving the parameters directly from those statistics, however, the SATM circuit provides those statistics to the parameter smoothing circuit 804.

The parameter smoothing circuit 804 may be configured to apply a smoothing filter to generate smoothed parameters for use on the current frame, based on the calculated statistics and based on the smoothed parameters that were generated for the previous frame (e.g., stored in memory register 808 or other suitable storage mechanism). In some embodiments, the parameter smoothing filter may be implemented as a first order infinite impulse response (IIR) filter (or exponential moving average filter), as described below:

SmoothParamX(n)=α*StatisticX(n)+(1−α)*SmoothParamX(n−1)

where the statistic X from the current frame n is weighted by a coefficient α and added to the smoothed parameter X from the previous frame n−1 weighted by (1−α) to generate the new smoothed parameter X for use on the current frame. The notation X is used to represent each of the four parameters: base offset, base ratio, base min and base max.

In some embodiments, initialization circuit 802 may be configured to provide an initial set of parameters, for example to be used on the first frame, for which the parameter smoothing circuit 804 would not have a set of previous frame smoothed parameters with which to work.

The coefficient α determines the strength or degree of smoothing of the filter. The value alpha may be chosen to meet specific requirements for each of the filtered SATM parameters. Because a correct value of the base min parameter is important for scene mapping, the a for base min parameter smoothing may be set to a relatively small value in order to speed up the adaptation process and prevent or reduce detail loss in dark regions of the image. On the other hand, more rapid changes of the ratio and offset parameters can result in sudden brightness variations in the output sequence, which is not desirable in video applications. Filter strengths for each of the parameters, which have been determined through experimental results to provide relatively good results, are shown in the following table:

TABLE 1

| parameter | α |
|---|---|
| base offset | 0.08 |
| base ratio | 0.04 |
| base min | 0.2 |
| base max | 0.04 |

Although the smoothing filter may address issues related to flicker between image frames, it does not provide for varying temporal contrast levels. The temporal contrast adaptation circuit 806 may be configured to compress the variation of SATM exposure correction between successive frames. The SATM process attempts to align the maximal value of the input HDR frame to a reference white value of the LDR frame. The base offset parameter is responsible for this exposure correction. To achieve different levels of temporal contrast, variations of the base offset around a selected reference value are compressed by the temporal contrast adaptation circuit 806, to an extent determined by the value of an adaptation parameter of the adaptation circuit described below:

base offset←reference offset+adaptation*(base offset−reference offset)

If the adaptation parameter is chosen to be zero then no adaptation will occur and the base offset will always be equal to the selected reference offset. If the adaptation parameter is chosen to be one, referred to as full adaptation, then the calculated base offset (e.g., from the smoothing filter) will be applied to each frame. In cases where the adaptation parameter is less than one (e.g. partial log domain adaptation), adaptations of the compression curve in the linear domain will tend to reverse this effect (the base max parameter will be significantly smaller than 1). Thus, adaptations of the tone compression curve should be limited. This can be achieved by setting the base max parameter to a constant value of 1.

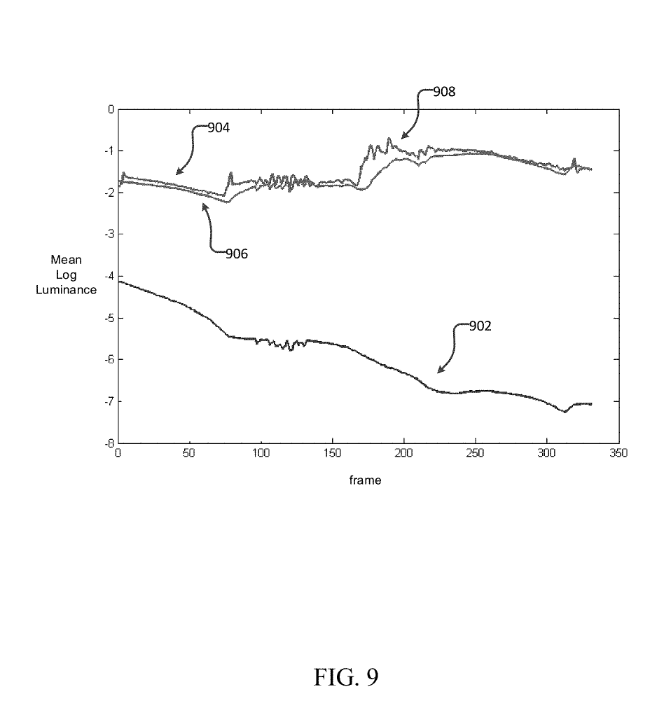

FIG. 9 is a plot illustrating results of temporal control processing over a range of video image frames, in accordance with certain of the embodiments disclosed herein. Plot 902 shows the variation in the mean log luminance versus frame number for a sample of HDR frames prior to SATM processing. As can be seen, the luminance may vary widely over time in the HDR image frames. Plot 904 illustrates the result of SATM processing without temporal control. As shown, the luminance range has been significantly compressed over the sequence of frames, but at the expense of introducing flicker 908. Plot 906 illustrates the result of SATM with temporal control including full adaptation and using the a coefficients from table 1. The luminance range has been compressed and smoothed to provide a more desirable video frame sequence with a reduction of frame to frame artifacts.

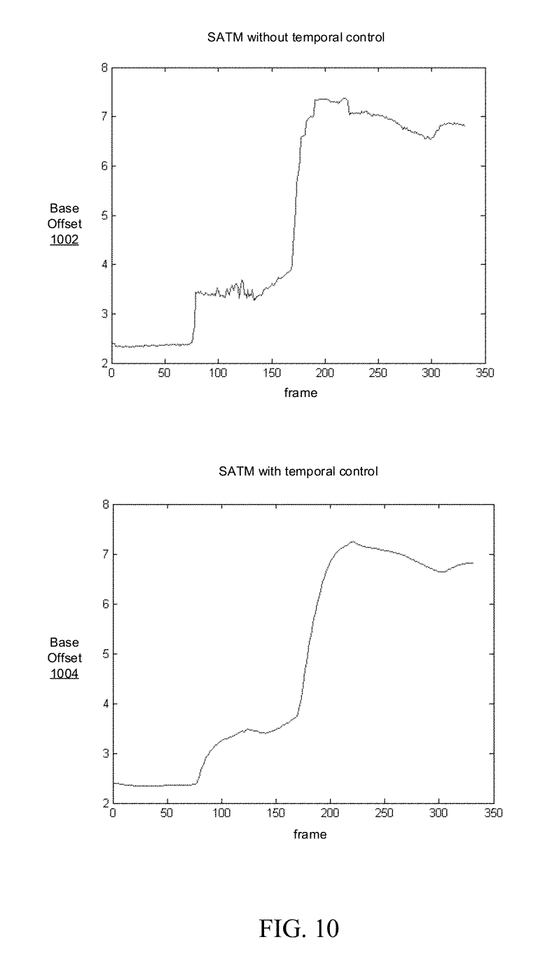

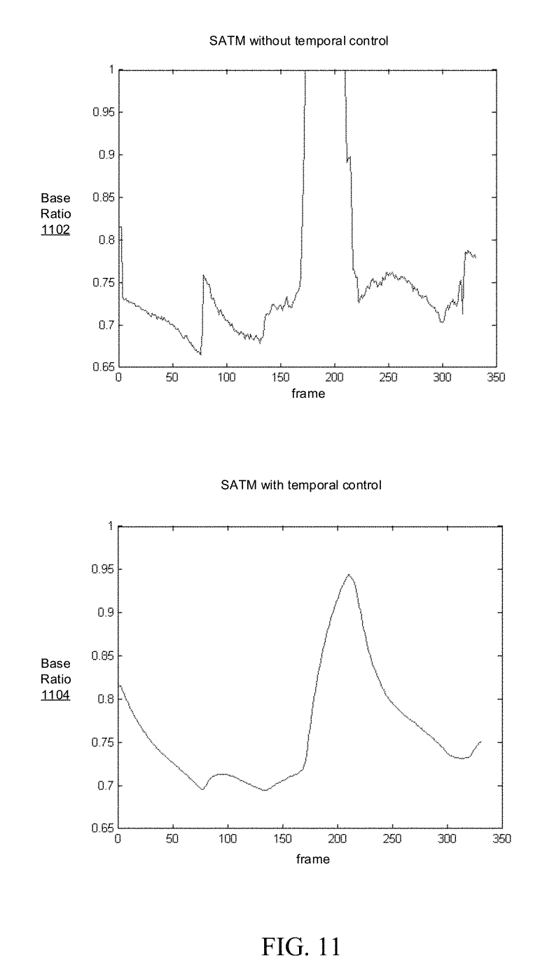

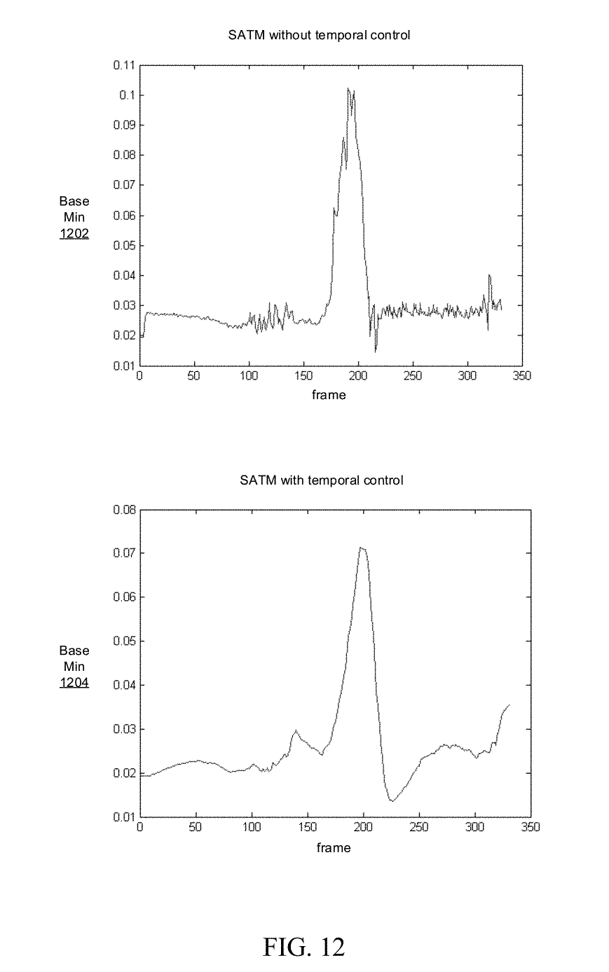

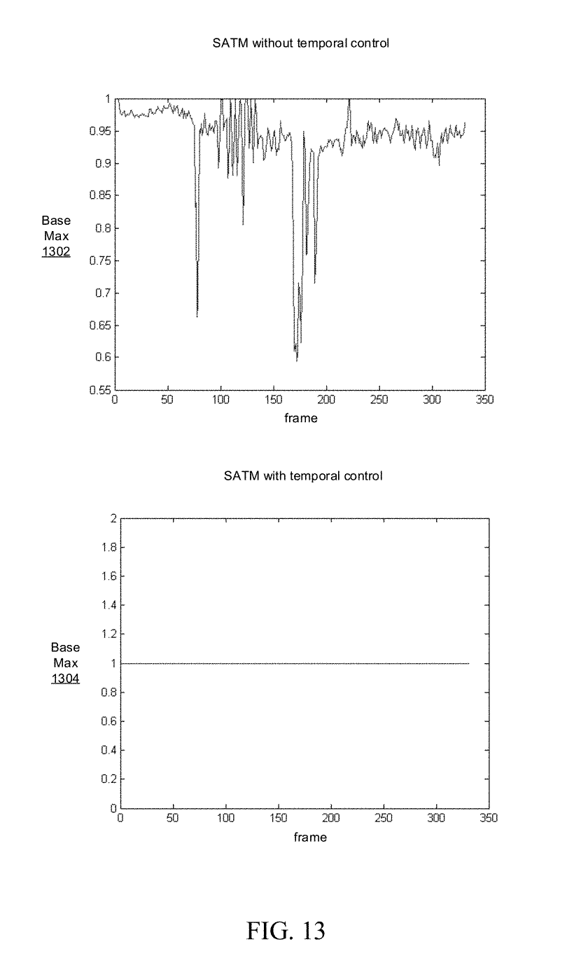

FIGS. 10-13 are plots illustrating the effect of temporal control processing on each of the parameters (base offset, base ratio, base min and base max) over a range of video image frames, in accordance with certain of the embodiments disclosed herein. In FIG. 10, the base offset parameter is shown for SATM without temporal control 1002 and with temporal control 1004. In FIG. 11, the base ratio parameter is shown for SATM without temporal control 1102 and with temporal control 1104. In FIG. 12, the base min parameter is shown for SATM without temporal control 1202 and with temporal control 1204. In each of these figures, it can be seen that temporal control provides smoothing of the relevant parameter. In FIG. 13, the base max parameter is shown for SATM without temporal control 1302. As described previously, the base max parameter with temporal control 1304 is set to a constant value of 1.

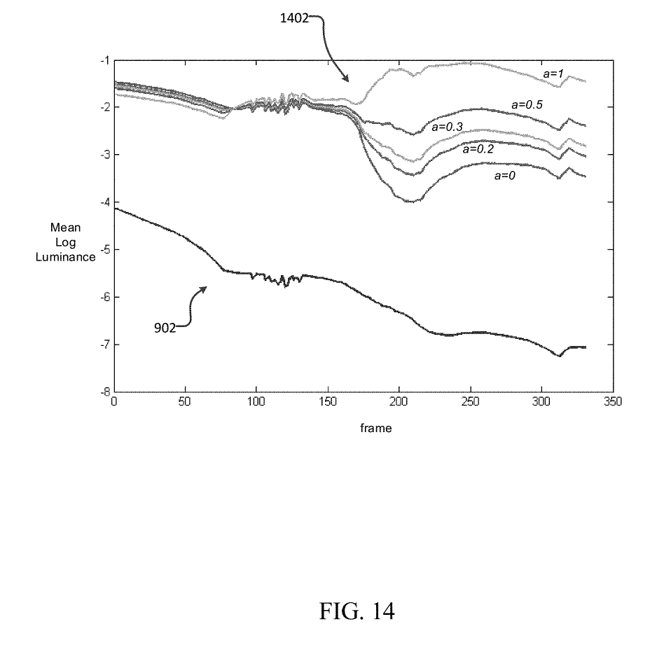

FIG. 14 is a plot illustrating results of temporal control processing with varying adaptation parameter over a range of video image frames, in accordance with certain of the embodiments disclosed herein. Plot 902 shows the variation in the mean log luminance versus frame number for a sample of HDR frames prior to SATM processing. Plots 1402 illustrate a collection of results of SATM with temporal control using a range of adaptation parameters (e.g., a=0, 0.2, 0.3, 0.5, and 1) as labeled.

Methodology

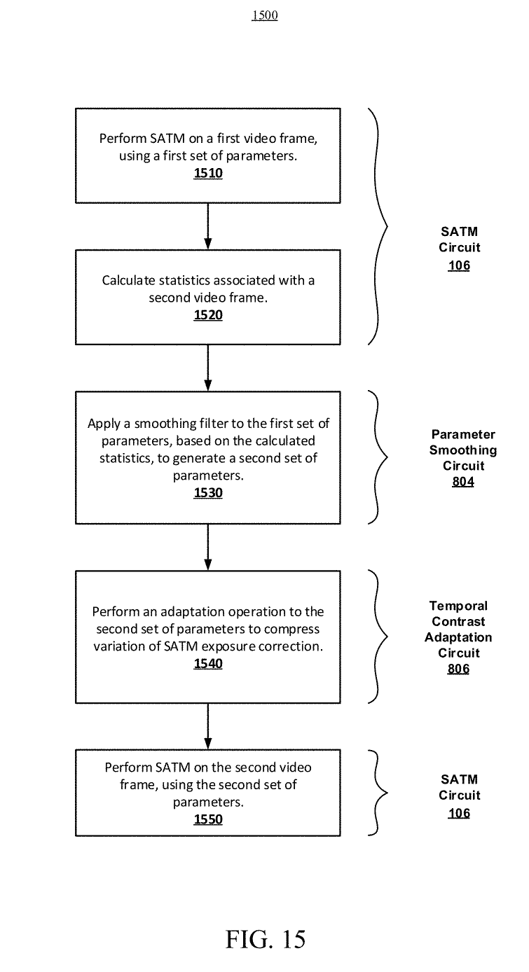

FIG. 15 is a flowchart illustrating an example method 1500 for spatially adaptive tone mapping with temporal control, in accordance with an embodiment of the present disclosure. As can be seen, example method 1500 includes a number of phases and sub-processes, the sequence of which may vary from one embodiment to another. However, when considered in the aggregate, these phases and sub-processes form a process for temporal control of spatially adaptive tone mapping in accordance with certain of the embodiments disclosed herein. These embodiments can be implemented, for example using the system architecture illustrated in FIG. 8 as described above. However other system architectures can be used in other embodiments, as will be apparent in light of this disclosure. To this end, the correlation of the various functions shown in FIG. 15 to the specific components illustrated in FIG. 8 is not intended to imply any structural and/or use limitations. Rather other embodiments may include, for example, varying degrees of integration wherein multiple functionalities are effectively performed by one system. For example, in an alternative embodiment a single module can be used to perform all of the functions of method 1500. Thus other embodiments may have fewer or more modules and/or sub-modules depending on the granularity of implementation. Numerous variations and alternative configurations will be apparent in light of this disclosure.

As illustrated in FIG. 15, in one embodiment, method 1500 for temporal control of spatially adaptive tone mapping commences by performing, at operation 1510, an SATM operation on a first selected frame (e.g., the current frame) of a sequence of video images. The video images may be received from an HDR camera or other suitable device capable of generating images with a dynamic range that exceeds the capabilities of typical display devices. The SATM operation is performed to reduce the dynamic range of the image frame. A set of parameters associated with that frame (e.g., a first set of parameters) are employed by the SATM operation. The parameters are related to the shifting and scaling of the base layer image as described previously. At operation 1520, statistics associated with a second selected frame (e.g., the next video frame) are calculated. In some embodiments, the statistics may include the minimum value of the amplitudes of the SATM base layer and the maximum value of the amplitudes of the SATM base layer.

Next, at operation 1530, a smoothing filter is applied to the first set of parameters, based on the calculated statistics of the second frame, to generate a second set of smoothed parameters. In some embodiments, the smoothing filter may be implemented as an infinite impulse response (IIR) filter. At operation 1540, an adaptation operation is performed on one of the second set of parameters (the parameter associated with SATM exposure correction) to compress the variation of SATM exposure correction from one frame to the next, relative to a selected reference value for the parameter. At operation 1550, an SATM operation is then performed on the second video frame, which may now be considered the new current frame, using the second set of smoothed and processed parameters.

Example System

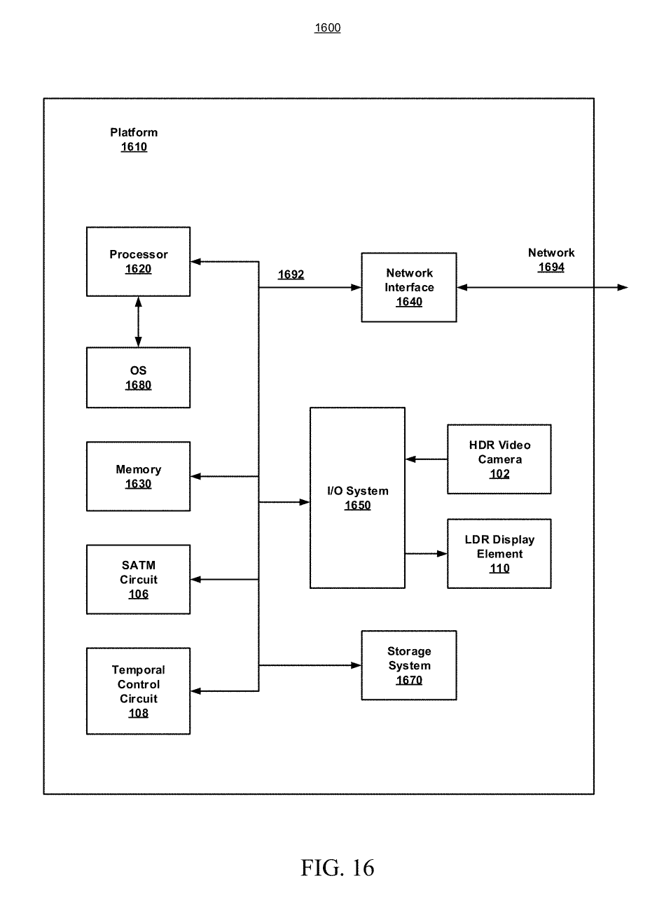

FIG. 16 illustrates an example system 1600 that may carry out spatially adaptive tone mapping with temporal control, for improved display of HDR video image sequences on devices with lower dynamic range capability, as described herein. In some embodiments, system 1600 comprises a platform 1610 which may host, or otherwise be incorporated into, a personal computer, workstation, laptop computer, ultra-laptop computer, tablet, touchpad, portable computer, handheld computer, palmtop computer, personal digital assistant (PDA), cellular telephone, combination cellular telephone and PDA, television, smart device (for example, smartphone, smart tablet or smart television), mobile internet device (MID), messaging device, data communication device, and so forth. Any combination of different devices may be used in certain embodiments.

In some embodiments, platform 1610 may comprise any combination of a processor 1620, a memory 1630, a spatially adaptive tone mapping (SATM) circuit 106, a temporal control circuit 108, a network interface 1640, an input/output (I/O) system 1650, an HDR video camera 102, an LDR display element 110 and a storage system 1670. As can be further seen, a bus and/or interconnect 1692 is also provided to allow for communication between the various components listed above and/or other components not shown. Platform 1610 can be coupled to a network 1694 through network interface 1640 to allow for communications with other computing devices, platforms or resources. Other componentry and functionality not reflected in the block diagram of FIG. 16 will be apparent in light of this disclosure, and it will be appreciated that other embodiments are not limited to any particular hardware configuration.

Processor 1620 can be any suitable processor, and may include one or more coprocessors or controllers, such as an audio processor or a graphics processing unit, to assist in control and processing operations associated with system 1600. In some embodiments, the processor 1620 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 1620 may be implemented as a complex instruction set computer (CISC) or a reduced instruction set computer (RISC) processor. In some embodiments, processor 1620 may be configured as an x86 instruction set compatible processor.

Memory 1630 can be implemented using any suitable type of digital storage including, for example, flash memory and/or random access memory (RAM). In some embodiments, the memory 1630 may include various layers of memory hierarchy and/or memory caches as are known to those of skill in the art. Memory 1630 may be implemented as a volatile memory device such as, but not limited to, a RAM, dynamic RAM (DRAM), or static RAM (SRAM) device. Storage system 1670 may be implemented as a non-volatile storage device such as, but not limited to, one or more of a hard disk drive (HDD), a solid state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 1670 may comprise technology to increase the storage performance enhanced protection for valuable digital media when multiple hard drives are included.

Processor 1620 may be configured to execute an Operating System (OS) 1680 which may comprise any suitable operating system, such as Google Android (Google Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with system 1600, and therefore may also be implemented using any suitable existing or subsequently-developed platform.

Network interface circuit 1640 can be any appropriate network chip or chipset which allows for wired and/or wireless connection between other components of computer system 1600 and/or network 1694, thereby enabling system 1600 to communicate with other local and/or remote computing systems, servers, and/or resources. Wired communication may conform to existing (or yet to developed) standards, such as, for example, Ethernet. Wireless communication may conform to existing (or yet to developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 1650 may be configured to interface between various I/O devices and other components of computer system 1600. I/O devices may include, but not be limited to, an HDR video camera 102, an LDR display element 110, and other devices not shown such as a keyboard, mouse, microphone, speaker, etc.

I/O system 1650 may include a graphics subsystem configured to perform processing of images for display element 110. Graphics subsystem may be a graphics processing unit or a visual processing unit (VPU), for example. An analog or digital interface may be used to communicatively couple graphics subsystem and display element 110. For example, the interface may be any of a high definition multimedia interface (HDMI), DisplayPort, wireless HDMI, and/or any other suitable interface using wireless high definition compliant techniques. In some embodiment, the graphics subsystem could be integrated into processor 1620 or any chipset of platform 1610. In some embodiments, display element 110 may comprise any television type monitor or display. Display element 110 may comprise, for example, a computer display screen, touchscreen display, video monitor, television-like device, and/or a television. Display element 110 may be digital and/or analog. Under the control of the OS 1680 (or one or more software applications), platform 1610 may display processed HDR video image sequences on display element 110. The HDR images may be provided by HDR video camera 102, or other sources, and processed by spatially adaptive tone mapping circuit 106 and temporal control circuit 108, as described herein.

It will be appreciated that in some embodiments, the various components of the system 100 may be combined or integrated in a system-on-a-chip (SoC) architecture. In some embodiments, the components may be hardware components, firmware components, software components or any suitable combination of hardware, firmware or software.

Spatially adaptive tone mapping circuit 102 is configured to perform dynamic range compression of HDR image frames of a video sequence, to preserve image details while providing contrast reduction, particularly in the highlight regions of the image. Temporal control circuit 108 is configured to smooth the SATM processed images to reduce flickering and other undesirable artifacts that may be introduced during SATM. SATM circuit 106 may include any or all of the components illustrated in FIGS. 2, 4 and 5 and described above. Temporal control circuit 108 may include any or all of the components illustrated in FIG. 8 described above. Circuits 106 and 108 can be implemented or otherwise used in conjunction with a variety of suitable software and/or hardware that is coupled to or that otherwise forms a part of system 1600. Circuits 106 and 108 can additionally or alternatively be implemented or otherwise used in conjunction with user I/O devices that are capable of providing information to, and receiving information and commands from, a user. These I/O devices may include display element 110, a textual input device such as a keyboard, and a pointer-based input device such as a mouse. Other input/output devices that may be used in other embodiments include a touchscreen, a touchpad, a speaker, and/or a microphone. Still other input/output devices can be used in other embodiments.

In some embodiments SATM circuit 106 and temporal control circuit 108 may be installed local to system 1600, as shown in the example embodiment of FIG. 16. Alternatively, system 1600 can be implemented in a client-server arrangement wherein at least some functionality associated with these circuits is provided to system 1600 using an applet, such as a JavaScript applet, or other downloadable module. Such a remotely accessible module or sub-module can be provisioned in real-time in response to a request from a client computing system for access to a given server having resources that are of interest to the user of the client computing system. In such embodiments the server can be local to network 1694 or remotely coupled to network 1694 by one or more other networks and/or communication channels. In some cases access to resources on a given network or computing system may require credentials such as usernames, passwords, and/or compliance with any other suitable security mechanism.

In various embodiments, system 1600 may be implemented as a wireless system, a wired system, or a combination of both. When implemented as a wireless system, system 1600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, system 1600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example in one embodiment at least one non-transitory computer readable storage medium has instructions encoded thereon that, when executed by one or more processors, cause one or more of the spatially adaptive tone mapping methodologies disclosed herein to be implemented. The instructions can be encoded using a suitable programming language, such as C, C++, object oriented C, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 1694. In other embodiments the functionalities disclosed herein can be incorporated into other software applications, such as video editing applications, video analysis applications, or other content generation, modification, and/or management applications. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus in other embodiments system 1600 may comprise additional, fewer, or alternative subcomponents as compared to those included in the example embodiment of FIG. 16.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Other embodiments may be implemented as software executed by a programmable control device. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a method for temporal control of spatially adaptive tone mapping (SATM). The method comprises: performing, by a processor, SATM on a first selected frame of a sequence of video images, to reduce dynamic range, the SATM based on a first set of parameters; calculating, by the processor, statistics associated with a second selected frame of the sequence of video images; applying, by the processor, a smoothing filter to the first set of parameters, based on the calculated statistics, to generate a second set of parameters; and performing, by the processor, SATM on the second frame, the SATM based on the second set of parameters.

Example 2 includes the subject matter of Example 1, further comprising performing an adaptation operation to at least one parameter of the second set of parameters, the at least one parameter associated with SATM exposure correction, to compress variation of SATM exposure correction between the first frame and the second frame relative to a selected reference value.

Example 3 includes the subject matter of Examples 1 or 2, wherein the adaptation operation is: base offset←reference offset+adaptation*(base offset−reference offset); wherein base offset is the parameter, of the second set of parameters, associated with SATM exposure correction; reference offset is the selected reference value; and adaptation is a selected adaptation parameter to control the rate of compression of the SATM exposure correction over time.

Example 4 includes the subject matter of any of Examples 1-3, further comprising setting the adaptation parameter to a value in the range of zero to one.

Example 5 includes the subject matter of any of Examples 1-4, wherein the SATM comprises: extracting luminance data associated with pixels from the first frame; converting the luminance data to a logarithm domain; decomposing the logarithm domain luminance data into a plurality of layers of varying detail; adjusting amplitudes of data in each of the layers, to map the corresponding amplitude data into a selected range; converting the adjusted layers from the logarithm domain to a linear domain; applying a global tone compression function to at least one of the layers to generate one or more compressed linear domain layers; and generating compressed luminance data based on a multiplicative product of the one or more compressed linear domain layers.

Example 6 includes the subject matter of any of Examples 1-5, wherein at least one of: the plurality of layers of varying detail includes a base layer, a small scale detail layer, and a large scale detail layer; the adjusting shifts and scales the amplitudes of the base layer and scales the amplitudes of the small scale layer and the large scale layer; the global tone compression function is applied to the converted linear domain base layer; and the parameters of the first and second sets of parameters comprise one or more of: the shift of the amplitudes of the base layer; the scale of the amplitudes of the base layer; a minimum value of the amplitudes of the base layer; and a maximum value of the amplitudes of the base layer.

Example 7 includes the subject matter of any of Examples 1-6, further comprising setting the parameter associated with the maximum value of the amplitudes of the base layer to a constant value.

Example 8 includes the subject matter of any of Examples 1-7, wherein the smoothing filter is a first order infinite impulse response (IIR) filter.

Example 9 is a system to apply temporal control to spatially adaptive tone mapping (SATM). The system comprises: an SATM circuit to perform SATM on a first selected frame of a sequence of video images, to reduce dynamic range, the SATM based on a first set of parameters; the SATM circuit further to calculate statistics associated with a second selected frame of the sequence of video images; and a parameter smoothing circuit to apply a smoothing filter to the first set of parameters, based on the calculated statistics, to generate a second set of parameters for the SATM circuit to perform SATM on the second frame.

Example 10 includes the subject matter of Example 9, further comprising a temporal contrast adaptation circuit to perform an adaptation operation to at least one parameter of the second set of parameters, the at least one parameter associated with SATM exposure correction, to compress variation of SATM exposure correction between the first frame and the second frame relative to a selected reference value.

Example 11 includes the subject matter of Examples 9 or 10, wherein the adaptation operation is: base offset←reference offset+adaptation*(base offset−reference offset); wherein base offset is the parameter, of the second set of parameters, associated with SATM exposure correction; reference offset is the selected reference value; and adaptation is a selected adaptation parameter to control the rate of compression of the SATM exposure correction over time.

Example 12 includes the subject matter of any of Examples 9-11, wherein the adaptation parameter is set to a value in the range of zero to one.

Example 13 includes the subject matter of any of Examples 9-12, wherein the SATM circuit comprises: a log-conversion circuit to convert luminance data, associated with pixels from the first frame, from a linear domain to a logarithm domain; an edge-aware filter circuit to decompose the logarithm domain luminance data into a plurality of layers of varying detail; an amplitude adjustment circuit to adjust amplitudes of data in each of the layers to map the corresponding amplitude data into a selected range; a linear-conversion circuit to convert the amplitude adjusted layers from the logarithm domain to a linear domain; a global tone compression circuit to apply a global tone compression function to at least one of the layers to generate one or more compressed linear domain layers; and a compressed luminance data reconstruction circuit to generate compressed luminance data based on a multiplicative product of the one or more compressed linear domain layers.

Example 14 includes the subject matter of any of Examples 9-13, wherein at least one of: the plurality of layers of varying detail includes a base layer, a small scale detail layer, and a large scale detail layer; the adjusting shifts and scales the amplitudes of the base layer and scales the amplitudes of the small scale layer and the large scale layer; the global tone compression function is applied to the converted linear domain base layer; and the parameters of the first and second sets of parameters comprise one or more of: the shift of the amplitudes of the base layer; the scale of the amplitudes of the base layer; a minimum value of the amplitudes of the base layer; and a maximum value of the amplitudes of the base layer.

Example 15 includes the subject matter of any of Examples 9-14, wherein the parameter associated with the maximum value of the amplitudes of the base layer is set to a constant value.

Example 16 includes the subject matter of any of Examples 9-15, wherein the smoothing filter is a first order infinite impulse response (IIR) filter.

Example 17 is at least one non-transitory computer readable storage medium having instructions encoded thereon that, when executed by one or more processors, result in the following operations for temporal control of spatially adaptive tone mapping. The operations comprise: performing SATM on a first selected frame of a sequence of video images, to reduce dynamic range, the SATM based on a first set of parameters; calculating statistics associated with a second selected frame of the sequence of video images; applying a smoothing filter to the first set of parameters, based on the calculated statistics, to generate a second set of parameters; and performing SATM on the second frame, the SATM based on the second set of parameters.

Example 18 includes the subject matter of Example 17, further comprising performing an adaptation operation to at least one parameter of the second set of parameters, the at least one parameter associated with SATM exposure correction, to compress variation of SATM exposure correction between the first frame and the second frame relative to a selected reference value.

Example 19 includes the subject matter of Examples 17 or 18, wherein the adaptation operation is: base offset←reference offset+adaptation*(base offset−reference offset); wherein base offset is the parameter, of the second set of parameters, associated with SATM exposure correction; reference offset is the selected reference value; and adaptation is a selected adaptation parameter to control the rate of compression of the SATM exposure correction over time.

Example 20 includes the subject matter of any of Examples 17-19, further comprising setting the adaptation parameter to a value in the range of zero to one.

Example 21 includes the subject matter of any of Examples 17-20, wherein the SATM comprises: extracting luminance data associated with pixels from the first frame; converting the luminance data to a logarithm domain; decomposing the logarithm domain luminance data into a plurality of layers of varying detail; adjusting amplitudes of data in each of the layers, to map the corresponding amplitude data into a selected range; converting the adjusted layers from the logarithm domain to a linear domain; applying a global tone compression function to at least one of the layers to generate one or more compressed linear domain layers; and generating compressed luminance data based on a multiplicative product of the one or more compressed linear domain layers.

Example 22 includes the subject matter of any of Examples 17-21, wherein at least one of: the plurality of layers of varying detail includes a base layer, a small scale detail layer, and a large scale detail layer; the adjusting shifts and scales the amplitudes of the base layer and scales the amplitudes of the small scale layer and the large scale layer; the global tone compression function is applied to the converted linear domain base layer; and the parameters of the first and second sets of parameters comprise one or more of: the shift of the amplitudes of the base layer; the scale of the amplitudes of the base layer; a minimum value of the amplitudes of the base layer; and a maximum value of the amplitudes of the base layer.

Example 23 includes the subject matter of any of Examples 17-22, further comprising setting the parameter associated with the maximum value of the amplitudes of the base layer to a constant value.

Example 24 includes the subject matter of any of Examples 17-23, wherein the smoothing filter is a first order infinite impulse response (IIR) filter.

Example 25 is a system for temporal control of spatially adaptive tone mapping (SATM). The system comprises: means for performing SATM on a first selected frame of a sequence of video images, to reduce dynamic range, the SATM based on a first set of parameters; means for calculating statistics associated with a second selected frame of the sequence of video images; means for applying a smoothing filter to the first set of parameters, based on the calculated statistics, to generate a second set of parameters; and means for performing SATM on the second frame, the SATM based on the second set of parameters.

Example 26 includes the subject matter of Example 25, further comprising means for performing an adaptation operation to at least one parameter of the second set of parameters, the at least one parameter associated with SATM exposure correction, to compress variation of SATM exposure correction between the first frame and the second frame relative to a selected reference value.

Example 27 includes the subject matter of Examples 25 or 26, wherein the adaptation operation is: base offset←reference offset+adaptation*(base offset−reference offset); wherein base offset is the parameter, of the second set of parameters, associated with SATM exposure correction; reference offset is the selected reference value; and adaptation is a selected adaptation parameter to control the rate of compression of the SATM exposure correction over time.

Example 28 includes the subject matter of any of Examples 25-27, further comprising means for setting the adaptation parameter to a value in the range of zero to one.

Example 29 includes the subject matter of any of Examples 25-28, wherein the SATM comprises: means for extracting luminance data associated with pixels from the first frame; means for converting the luminance data to a logarithm domain; means for decomposing the logarithm domain luminance data into a plurality of layers of varying detail; means for adjusting amplitudes of data in each of the layers, to map the corresponding amplitude data into a selected range; means for converting the adjusted layers from the logarithm domain to a linear domain; means for applying a global tone compression function to at least one of the layers to generate one or more compressed linear domain layers; and means for generating compressed luminance data based on a multiplicative product of the one or more compressed linear domain layers.

Example 30 includes the subject matter of any of Examples 25-29, wherein at least one of: the plurality of layers of varying detail includes a base layer, a small scale detail layer, and a large scale detail layer; the adjusting shifts and scales the amplitudes of the base layer and scales the amplitudes of the small scale layer and the large scale layer; the global tone compression function is applied to the converted linear domain base layer; and the parameters of the first and second sets of parameters comprise one or more of: the shift of the amplitudes of the base layer; the scale of the amplitudes of the base layer; a minimum value of the amplitudes of the base layer; and a maximum value of the amplitudes of the base layer.

Example 31 includes the subject matter of any of Examples 25-30, further comprising means for setting the parameter associated with the maximum value of the amplitudes of the base layer to a constant value.

Example 32 includes the subject matter of any of Examples 25-31, wherein the smoothing filter is a first order infinite impulse response (IIR) filter.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. A processor-implemented method for temporal control of spatially adaptive tone mapping (SATM), the method comprising:
performing, by a processor, SATM on a first selected frame of a sequence of video images, to reduce dynamic range, the SATM based on a first set of parameters;
calculating, by the processor, statistics associated with a second selected frame of the sequence of video images;
applying, by the processor, a smoothing filter to the first set of parameters, based on the calculated statistics, to generate a second set of parameters; and
performing, by the processor, SATM on the second frame, the SATM based on the second set of parameters.

2. The method of claim 1, further comprising performing an adaptation operation to at least one parameter of the second set of parameters, the at least one parameter associated with SATM exposure correction, to compress variation of SATM exposure correction between the first frame and the second frame relative to a selected reference value.

3. The method of claim 2, wherein the adaptation operation is:
base offset←reference offset+adaptation*(base offset−reference offset);
wherein base offset is the parameter, of the second set of parameters, associated with SATM exposure correction; reference offset is the selected reference value; and
adaptation is a selected adaptation parameter to control the rate of compression of the SATM exposure correction over time.

4. The method of claim 3, further comprising setting the adaptation parameter to a value in the range of zero to one.

5. The method of claim 1, wherein the SATM comprises:
extracting luminance data associated with pixels from the first frame;
converting the luminance data to a logarithm domain;
decomposing the logarithm domain luminance data into a plurality of layers of varying detail;
adjusting amplitudes of data in each of the layers, to map the corresponding amplitude data into a selected range;
converting the adjusted layers from the logarithm domain to a linear domain;
applying a global tone compression function to at least one of the layers to generate one or more compressed linear domain layers; and
generating compressed luminance data based on a multiplicative product of the one or more compressed linear domain layers.

6. The method of claim 5, wherein at least one of:
the plurality of layers of varying detail includes a base layer, a small scale detail layer, and a large scale detail layer;
the adjusting shifts and scales the amplitudes of the base layer and scales the amplitudes of the small scale layer and the large scale layer;
the global tone compression function is applied to the converted linear domain base layer; and
the parameters of the first and second sets of parameters comprise one or more of: the shift of the amplitudes of the base layer; the scale of the amplitudes of the base layer; a minimum value of the amplitudes of the base layer; and a maximum value of the amplitudes of the base layer.

7. The method of claim 6, further comprising setting the parameter associated with the maximum value of the amplitudes of the base layer to a constant value.

8. The method of claim 1, wherein the smoothing filter is a first order infinite impulse response (IIR) filter.

9. A system to apply temporal control to spatially adaptive tone mapping (SATM), the system comprising:
an SATM circuit to perform SATM on a first selected frame of a sequence of video images, to reduce dynamic range, the SATM based on a first set of parameters;
the SATM circuit further to calculate statistics associated with a second selected frame of the sequence of video images; and
a parameter smoothing circuit to apply a smoothing filter to the first set of parameters, based on the calculated statistics, to generate a second set of parameters for the SATM circuit to perform SATM on the second frame.

10. The system of claim 9, further comprising a temporal contrast adaptation circuit to perform an adaptation operation to at least one parameter of the second set of parameters, the at least one parameter associated with SATM exposure correction, to compress variation of SATM exposure correction between the first frame and the second frame relative to a selected reference value.

11. The system of claim 10, wherein the adaptation operation is:
base offset←reference offset+adaptation*(base offset reference offset);
wherein base offset is the parameter, of the second set of parameters, associated with SATM exposure correction; reference offset is the selected reference value; and adaptation is a selected adaptation parameter to control the rate of compression of the SATM exposure correction over time.

12. The system of claim 11, wherein the adaptation parameter is set to a value in the range of zero to one.

13. The system of claim 9, wherein the SATM circuit comprises:
a log-conversion circuit to convert luminance data, associated with pixels from the first frame, from a linear domain to a logarithm domain;
an edge-aware filter circuit to decompose the logarithm domain luminance data into a plurality of layers of varying detail;
an amplitude adjustment circuit to adjust amplitudes of data in each of the layers to map the corresponding amplitude data into a selected range;
a linear-conversion circuit to convert the amplitude adjusted layers from the logarithm domain to a linear domain;
a global tone compression circuit to apply a global tone compression function to at least one of the layers to generate one or more compressed linear domain layers; and
a compressed luminance data reconstruction circuit to generate compressed luminance data based on a multiplicative product of the one or more compressed linear domain layers.

14. The system of claim 13, wherein at least one of:
the plurality of layers of varying detail includes a base layer, a small scale detail layer, and a large scale detail layer;
the adjusting shifts and scales the amplitudes of the base layer and scales the amplitudes of the small scale layer and the large scale layer;
the global tone compression function is applied to the converted linear domain base layer; and
the parameters of the first and second sets of parameters comprise one or more of: the shift of the amplitudes of the base layer; the scale of the amplitudes of the base layer; a minimum value of the amplitudes of the base layer; and a maximum value of the amplitudes of the base layer.

15. The system of claim 14, wherein the parameter associated with the maximum value of the amplitudes of the base layer is set to a constant value.

16. The system of claim 9, wherein the smoothing filter is a first order infinite impulse response (IIR) filter.

17. At least one non-transitory computer readable storage medium having instructions encoded thereon that, when executed by one or more processors, result in the following operations for temporal control of spatially adaptive tone mapping, the operations comprising:
performing SATM on a first selected frame of a sequence of video images, to reduce dynamic range, the SATM based on a first set of parameters;
calculating statistics associated with a second selected frame of the sequence of video images;
applying a smoothing filter to the first set of parameters, based on the calculated statistics, to generate a second set of parameters; and
performing SATM on the second frame, the SATM based on the second set of parameters.

18. The computer readable storage medium of claim 17, further comprising performing an adaptation operation to at least one parameter of the second set of parameters, the at least one parameter associated with SATM exposure correction, to compress variation of SATM exposure correction between the first frame and the second frame relative to a selected reference value.

19. The computer readable storage medium of claim 18, wherein the adaptation operation is:
base offset←reference offset+adaptation*(base offset−reference offset);
wherein base offset is the parameter, of the second set of parameters, associated with SATM exposure correction; reference offset is the selected reference value; and adaptation is a selected adaptation parameter to control the rate of compression of the SATM exposure correction over time.

20. The computer readable storage medium of claim 19, further comprising setting the adaptation parameter to a value in the range of zero to one.

21. The computer readable storage medium of claim 17, wherein the SATM comprises:
extracting luminance data associated with pixels from the first frame;
converting the luminance data to a logarithm domain;
decomposing the logarithm domain luminance data into a plurality of layers of varying detail;
adjusting amplitudes of data in each of the layers, to map the corresponding amplitude data into a selected range;
converting the adjusted layers from the logarithm domain to a linear domain;
applying a global tone compression function to at least one of the layers to generate one or more compressed linear domain layers; and
generating compressed luminance data based on a multiplicative product of the one or more compressed linear domain layers.

22. The computer readable storage medium of claim 21, wherein at least one of:
the plurality of layers of varying detail includes a base layer, a small scale detail layer, and a large scale detail layer;
the adjusting shifts and scales the amplitudes of the base layer and scales the amplitudes of the small scale layer and the large scale layer;
the global tone compression function is applied to the converted linear domain base layer; and
the parameters of the first and second sets of parameters comprise one or more of: the shift of the amplitudes of the base layer; the scale of the amplitudes of the base layer; a minimum value of the amplitudes of the base layer; and a maximum value of the amplitudes of the base layer.

23. The computer readable storage medium of claim 22, further comprising setting the parameter associated with the maximum value of the amplitudes of the base layer to a constant value.

24. The computer readable storage medium of claim 17, wherein the smoothing filter is a first order infinite impulse response (IIR) filter.
